(19) United States
(12) Patent Application Publication
(10) Pub. No.: US 2019/0102744 A1
(43) Pub. Date: Apr. 4, 2019

(54) Method of Facilitating Quality Work Relationships Between Job Seekers and Job Providers

(71) Applicant: Aaron Kyle Elliott, Shreveport, LA (US)

(72) Inventor: Aaron Kyle Elliott, Shreveport, LA (US)

(21) Appl. No.: 16/149,924

(22) Filed: Oct. 2, 2018

Related U.S. Application Data
(60) Provisional application No. 62/566,866, filed on Oct. 2, 2017.

(51) Int. Cl. G06Q 10/10; H04L 29/06; G06Q 30/08

(52) U.S. Cl. CPC G06Q 10/1053; G06Q 30/08; H04L 63/083

(57) ABSTRACT

Method of facilitating quality work relationships between job seekers and job providers includes providing a plurality of seeker accounts and a plurality of provider accounts. Each provider account is associated with a location-tracking provider device. Similarly, each seeker account is associated with a location-tracking seeker device. An arbitrary provider account posts a job request that can be fulfilled by at least one seeker account. A remote server uses location data gathered through the location tracking seeker PC device of the plurality of seeker accounts to generate a plurality of desired accounts. The plurality of desired accounts includes one or more seeker accounts that are closest to the arbitrary provider account. The plurality of desired accounts then place bids on the job request. Subsequently, the arbitrary provider account choses the winning seeker account based on the bid and the reputation of the winning seeker account.

The current application claims a priority to the U.S. Provisional Patent application Ser. No. 62/566,866 filed on Oct. 2, 2017.

### FIELD OF THE INVENTION

The present invention generally relates to a method of facilitating quality work relationships between job seekers and job providers. The method implements a job board whereby job seekers inspect, dispute, and place bids on job requests submitted by job providers.

### BACKGROUND OF THE INVENTION

In today's world, thousands of companies and professionals are hiring workers online. The trend of hiring workers online is growing day by day as the online industry rapidly evolves. Further, there is a huge number of online hiring platforms such as, but not limited to, websites, web applications, and mobile applications, which have been developed to facilitate online hiring. Furthermore, online hiring platforms provide hiring for profiles, such as, but not limited to, website development, coding, data entry, home tutors, electricians, plumbers, gardeners, drivers, repair personnel, etc.

Further, there has been an exponential increase in the number of smartphone users across the world. As a result of easy accessibility to the Internet, online hiring platforms have made it possible for companies and/or workers to communicate directly with each other. Further, online hiring platforms have transformed hiring by aiding quick connectivity between jobseekers and the opportunities that match their needs.

However, online hiring is not free from challenges that usually arise during traditional hiring. Accordingly, the shift towards online hiring is not without risk. Further, online hiring platforms generally focus on screening out candidates and not identifying top candidates. Hence, the online hiring platforms currently follow a “weeding-out” approach. Further, the “weeding-out” approach may lead to companies overlooking jobseekers and/or job providers that may be a perfect fit for them.

Further, currently, online hiring platforms largely focus on keywords, résumé buzzwords, and/or personality test scores. Furthermore, online hiring platforms also depersonalize the hiring process by focusing heavily on metrics and grading scales, rather than truly connecting candidates with companies so hiring teams can really get a picture of their skills and/or motivation. Accordingly, this makes it possible for companies to lose sight of potential jobseekers who are suitable for filling the vacancy.

Further, online hiring platforms currently do not screen jobseekers and/or job providers based on the location information. Accordingly, this increases the burden on the job requester, as the job requester is forced to screen potential job providers from a large pool of available job providers.

Further, currently online hiring platforms do not monitor actual job progress after hiring is accomplished. Accordingly, the job requester and the job provider are isolated. Further, online hiring platforms have risks associated with confidential information, data security, and disputes arising between the job requester and the job providers.

Further, generally, online hiring platforms follow an approach wherein the job requester and the job providers rate each other manually based on performance. Accordingly, there is no system to analyze and objectively validate the ratings given by the job requester and the job provider.

Further, in existing online hiring platforms tend to be misused by some users who post job requests of a legally questionable nature. In other words, the ad-hoc nature of an online hiring platform may be exploited by some users to undertake illegal activities.

Therefore, there is a need for improved methods and system for facilitating matching between job requests and job providers that may overcome one or more of the abovementioned problems and/or limitations.

### BRIEF DESCRIPTION OF THE DRAWINGS

FIG. 1A is a block diagram of the system of the present invention.

FIG. 1B is a flowchart of the general process of the present invention.

FIG. 2 is a flowchart illustrating the subprocess of selecting a winner account from multiple arbitrary seeker accounts.

FIG. 3 is a flowchart illustrating the subprocess for compiling the bid from each arbitrary seeker account into a list of bids.

FIG. 4 is a flowchart illustrating the subprocess for capturing and relaying the job progress data from a monitoring device to the remote server.

FIG. 5 is a flowchart illustrating the subprocess for prompting each provider account to submit a job description with the job request.

FIG. 6 is a flowchart illustrating the subprocess for using an accumulative seeker reputation rating as the contextual data for each seeker account.

FIG. 7 is a flowchart illustrating the subprocess for providing a seeker review for the winning seeker account and updating the accumulative seeker reputation rating.

FIG. 8 is a flowchart illustrating the subprocess for updating the accumulative seeker reputation rating with a seeker review from the arbitrary provider account, if the winning seeker account cancels the job request.

FIG. 9 is a flowchart illustrating the subprocess for using an accumulative provider reputation rating as the contextual data for each provider account.

FIG. 10 is a flowchart illustrating the subprocess for providing a provider review for the arbitrary provider account and updating the accumulative provider reputation rating.

FIG. 11 is a flowchart illustrating the subprocess for updating the accumulative provider reputation rating with a new provider review, if the arbitrary provider account cancels the job request.

FIG. 12 is a flowchart illustrating the subprocess for using a current location as the contextual data for each seeker account.

FIG. 13 is a flowchart illustrating the subprocess for using a maximum number of bidder to reduce the plurality of desired accounts.

### DETAILED DESCRIPTION OF THE INVENTION

All illustrations of the drawings are for the purpose of describing selected versions of the present invention and are not intended to limit the scope of the present invention.

The present invention is a method of facilitating work relationships between job seekers and job providers located in the same general area. The method facilitates an online community wherein users can post free-form job requests or bid on job requests posted by other users. Preferably, the online community is only accessible to a plurality of users, wherein each user is selected based on his or her reputation, location, and qualifications. A user may be, but is not limited to, a person, a business, a software component, an automated computing device, or a service of an automated computing device. Using the online community, the plurality of users may offer job requests, place bids, negotiate payments, and resolve disputes related to the job requests. The bids are herein referred to as monetary bids. Preferably, each of the plurality of users owns a user account for interacting and communicating with other users. The user account may be created through a user registration process. During the user registration process, a user must agree to terms and conditions related to posting, canceling, paying for, receiving payment for, cancelling, and/or disputing the job request. The user must also provide user credentials such as a username and a password, for preventing unauthorized access to the user account.

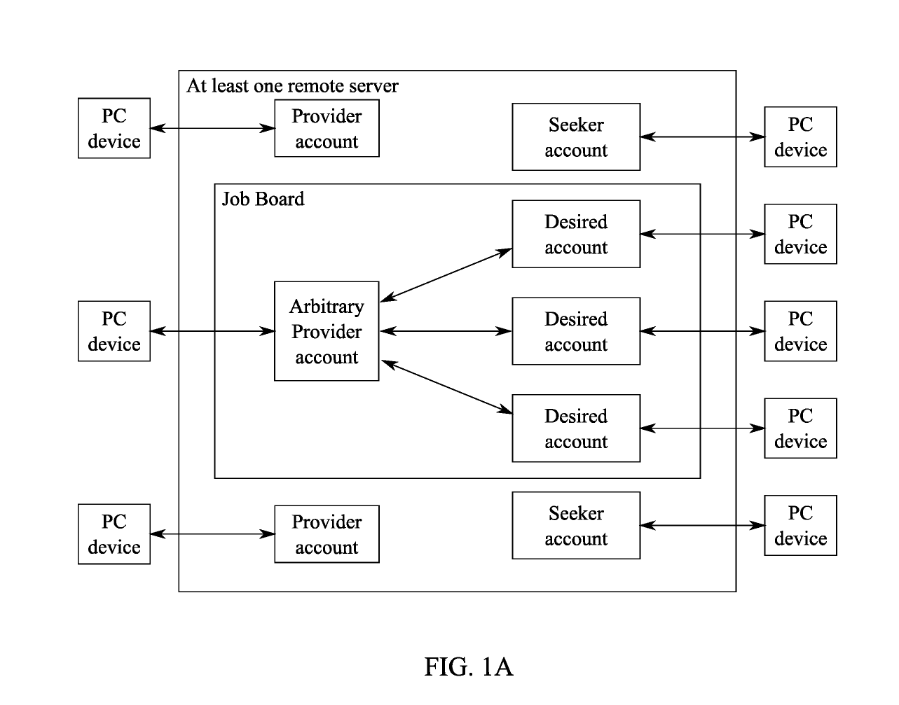

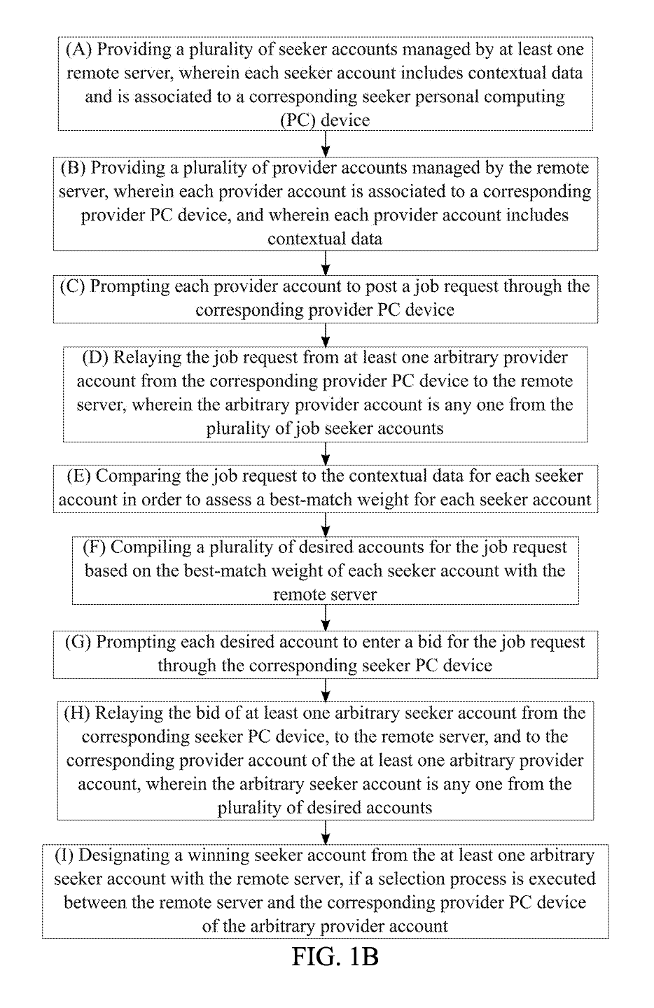

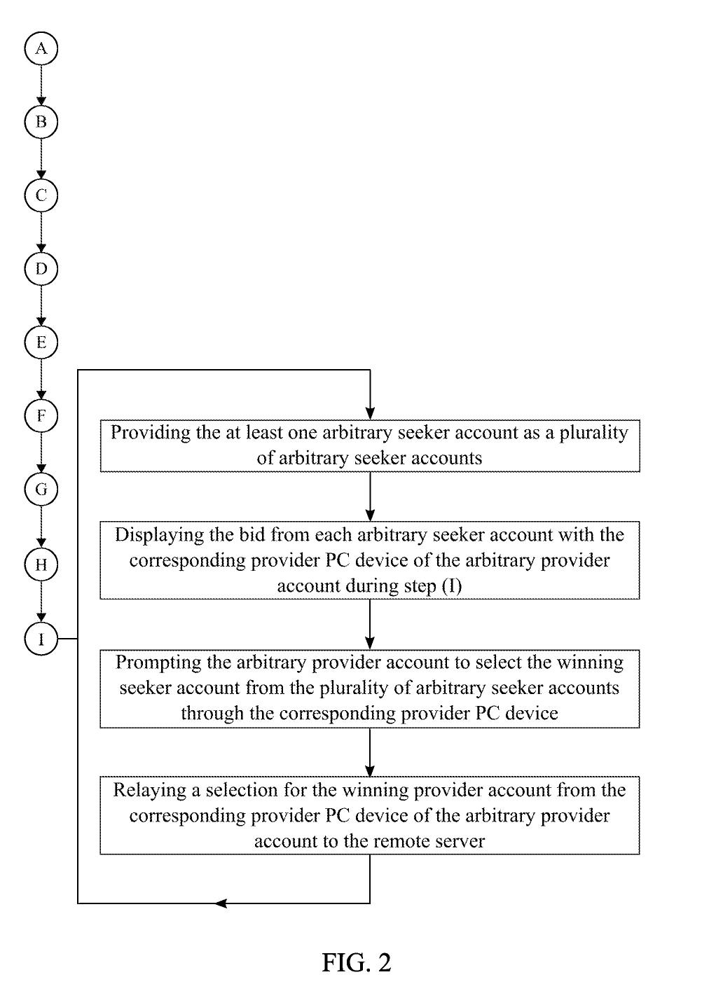

Referring to FIG. 1A and FIG. 1B, in the preferred embodiment, a plurality of seeker accounts managed by at least one remote server is provided, wherein each seeker account includes contextual data and is associated to a corresponding seeker personal computing (PC) device (Step A). As can be seen in FIG. 2, each of the plurality of seeker accounts may be an arbitrary user account capable of receiving the job request notification and bidding on the job request. To receive job notifications and bid on job requests, the user of a seeker account must undergo continual background checks, by location, credit score, or by an administrator of the system. Further, the user must input identification or personal information, such as an image of a license of passport, a driver's license number, an identification number, professional certifications, licenses, company badges, or any identification that follows the RealID act standards. Once the user provides this information, the arbitrary user account is designated as the seeker account. In the preferred implementation, the payment information is entered through the corresponding seeker PC device and stored in the remote server.

Similarly, a plurality of provider accounts managed by the remote server is provided, wherein each provider account is associated to a corresponding provider PC device, and wherein each provider account includes contextual data (Step B). Each of the plurality of provider accounts, as herein referred to, is a seeker account capable of posting a job request. Preferably, the plurality of provider accounts is stored and managed by at least one remote server. To enable job posting function, the user of the arbitrary user account must at least provide payment information during or after the registration process. The payment information includes, but is not limited to, bank account numbers, credit/debit card numbers, electronic routing numbers, and the like. In one possible embodiment, the payment information may be gathered via a job creation page provided in the arbitrary user account. If the user has not entered the payment information or the payment information is not valid, the job creation page prompts the user to enter the valid payment information. Payment information is entered manually by typing or automatically generated, for example, with an image of a customer's credit card and optical character recognition to interpret the payment information from the credit card image. Once the payment information is provided, the remote server designates the arbitrary user account as the provider account. In the preferred implementation, the payment information is entered through the corresponding provider PC device and stored in the remote server.

Both the provider PC device and the seeker PC device can be, but are not limited to, smartphones, laptops, desktop, personal digital assistants (PDAs), smartwatches, and the like. In the preferred implementation, both the seeker PC device and the provider PC device are in wireless communication with the at least one remote server. Accordingly, the contextual data for each of the plurality of provider accounts is acquired through the corresponding PC provider PC device. Similarly, the contextual data for the each of the plurality of seeker accounts is acquired through the corresponding seeker PC device.

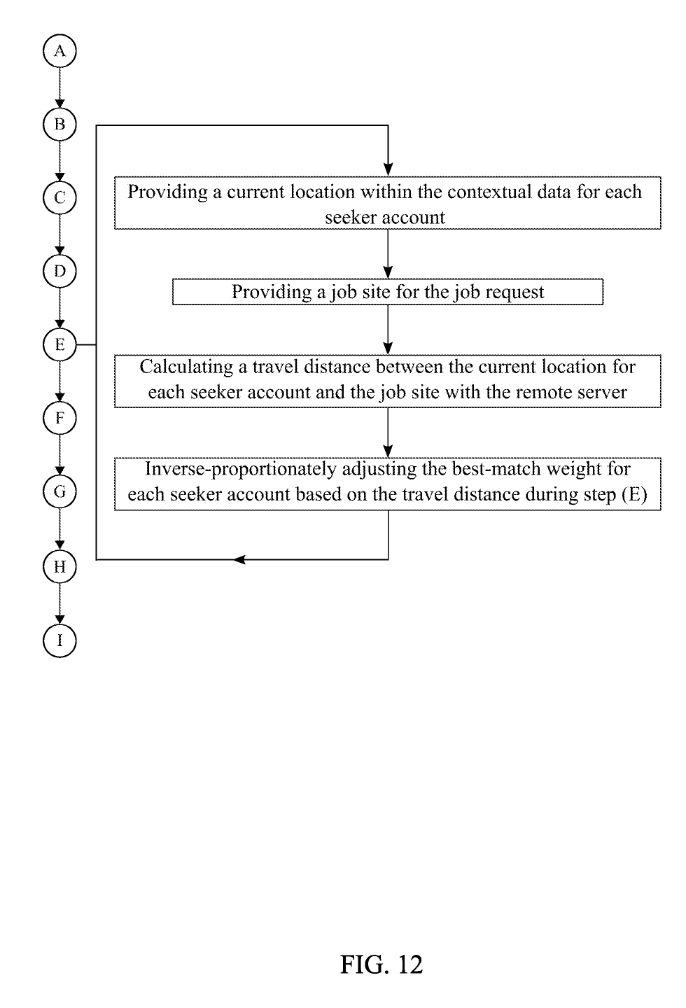

Referring to FIG. 1B and FIG. 12, in one possible embodiment, the contextual data for each of the plurality of provider accounts may be the location of the corresponding user. Similarly, the contextual data for each of the plurality of seeker accounts may be the location of the corresponding user. To achieve this, the corresponding seeker PC device and the corresponding provider PC device may be equipped with a location-tracking device.

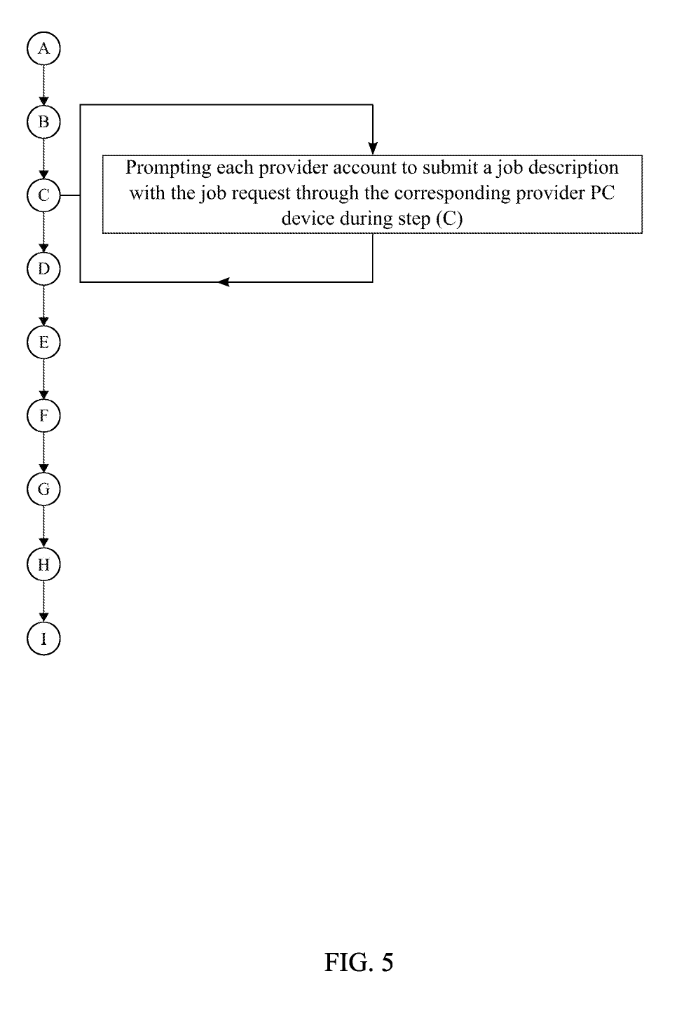

Referring to FIG. 1B and FIG. 5, using the contextual data for the provider account and the seeker account, the remote server distributes jobs amongst the plurality of seeker accounts. Accordingly, the corresponding PC device prompts each provider account to post a job request (Step C). In the preferred embodiment, the user creates the job request via the job creation page. The job creation page includes input fields for a short job description such as a title, a detailed job description, a desired work schedule, and the location of the job site. The location may be user generated or automatically generated from the user's current location, geographical coordinates, and/or an address of the user's choosing. Further, an authentication process may be executed by either the corresponding provider PC device or the remote server to determine if the job request is valid according to the laws, codes, regulations, or rules programmed into the remote server.

Subsequently, the corresponding provider PC device relays the job request from at least one arbitrary provider account to the remote server, wherein the arbitrary provider account is any one from the plurality of job seeker accounts (Step D). In the preferred embodiment, the information for the job request is stored in the memory of the corresponding provider PC device and then sent to the remote server. Alternately, the information for the job request may be entered to the corresponding provider PC device and sent to directly to the remote server. The job request can then be created by the remote server.

The remote server then compares the job request to the contextual data for each seeker account in order to assess a best-match weight for each seeker account (Step E).

More specifically, the best-match weight for each seeker account is determined by comparing the contextual data for each of the seeker account to the description of the job request, the information stored in the remote server about the arbitrary provider account, reviews and ratings stored in the remote server about the arbitrary provider account, and/or the location of the job site of the job request. This is used to filter the plurality of seeker accounts to a small number of most well-suited seeker accounts. The contextual data itself may comprise a plurality of datapoints. The plurality of datapoints may include ratings, reviews, location, certifications, licenses, company badges, personal information, and/or background checks of the seeker account.

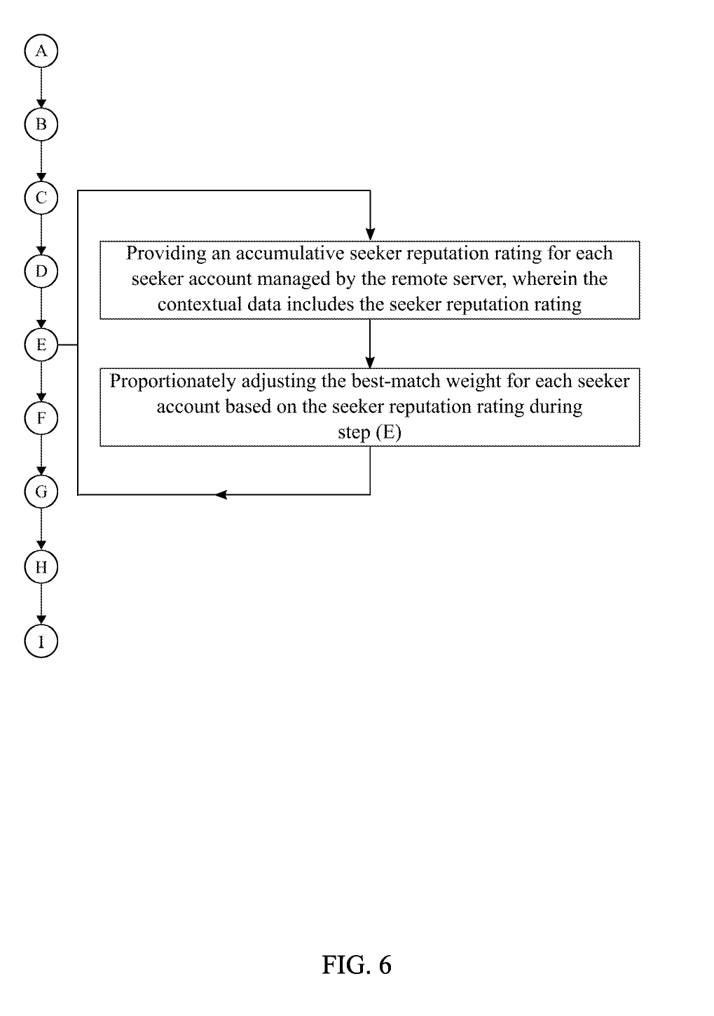

Referring to FIG. 1B and FIG. 6, in the preferred embodiment, the seeker account is only given a best-match weight if one or more datapoints of the contextual data matches the job request. For example, the remote server may use the location as the contextual data of each seeker account. In this case, the remote server only gives the best-match weight to the seeker account, if the distance between the user of the seeker account and the job site is less than a preset amount given in the job request or automatically generated by the remote server. Further, the remote server may also use the user profile as the contextual data of each seeker account in addition to the location. In this case, the remote server only gives the best-match weight to the seeker account, if the user profile of the seeker account contains certain keywords found in the description of the job request. Alternately, the seeker account may only be given the best-match weight if more than one datapoints match the job request. If the contextual data of the seeker account contains both the datapoints, the remote server adjusts the best-match weight according to the weight given to each of the datapoints. The weight assigned to each datapoint may itself change according to the information stored about the arbitrary provider account sending the job request and the seeker account bidding on the job request.

Subsequently, the remote server compiles a plurality of desired accounts for the job request based on the best-match weight of each seeker account (Step F). Each of the plurality of desired seekers is the seeker account with contextual data that matches the job request. More specifically, the contextual data for each desired account, may contain one or more datapoints that match the job request.

The remote server then prompts each desired account to enter a bid for the job request through the corresponding seeker PC device (Step G). The bid, as herein referred to, is the desired monetary compensation demanded by the desired seeker for accepting the job request. The desired seeker account bid may be a lump sum amount or may be divided into periodic installments. In the preferred embodiment, each desired account places the bid via a job board. As such, the remote server invites each of the plurality desired accounts to join the job board. Preferably, the job board is embodied in a graphical user interface displayed on the corresponding seeker PC device. Similarly, the arbitrary provider account monitors and manages the bid from the plurality of desired accounts through the job board. As such, the job board may be embodied in the graphical user interface displayed on the corresponding provider PC device. The job board displays the job request, the job description, and allows the plurality of desired accounts to interact with the arbitrary provider account. Information that may be on the job board can include, but isn't limited to, a job title, job details, job terms, desired date and time range, desired location, desired price range, urgency for bids, bid(s), bid statuses, job board status, messages, and/or images. Through the job board, the desired account can place the bid for the job request.

In the preferred embodiment, the remote server relays the bid of at least one arbitrary seeker account from the corresponding seeker PC device to the corresponding provider account of the at least one arbitrary provider account, wherein the arbitrary seeker account is any one from the plurality of desired accounts (Step H). Accordingly, it is not required for each desired account to place a bid. Preferably, if at least one desired account places the bid, the arbitrary provider account may accept the bid or solicit the plurality of desired accounts place the bid again. However, if none of the plurality of desired accounts submits a bid, the arbitrary provider account may adjust the desired price range, command the remote server to generate a new plurality of desired accounts, or close the job board.

The remote server then designates a winning seeker account from the at least one arbitrary seeker account, if a selection process is executed between the remote server and the corresponding provider PC device of the arbitrary provider account (Step I). The selection process allows the arbitrary provider account to review the bid from the at least one arbitrary seeker account. More specifically, the selection process allows the arbitrary provider account to check the ratings and reviews of the at least one arbitrary seeker account in order to choose the winning seeker. In one embodiment, the selection process may require the arbitrary seeker account to place the bid within a time limit. Alternately, the selection process may continue until the arbitrary provider account accepts the bid.

In the preferred embodiment, the payment is disbursed immediately after the arbitrary provider account accepts a bid from the winning seeker account. When the arbitrary provider account pays, the arbitrary provider account is required to pay the amount listed on the bid being accepted in addition to any applicable fees. Once the bid is accepted, the notification that the bid was accepted appears on the corresponding seeker PC device of the winning seeker account and the status of the associated job is set to open. Cancellation fees, payment processing fees, and additional fees may apply depending on a variety of factors, for example, municipal fees, taxes, safety fees, insurance fees. The payment may be disbursed to the winning seeker account, for instance, using a payroll processor, an electronic fund transfer, electronic or blockchain currency, a check, or another payment method. Further, an escrow service may be provided to ensure the winning seeker account receives the payment on time.

Referring to FIG. 2, in a possible embodiment of the present invention, the selection process is modified if more than one desired account places the bid. As such, a plurality of arbitrary seeker accounts is provided as the at least one arbitrary seeker account. Subsequently, the corresponding provider PC device of the arbitrary provider account displays the bid from each arbitrary seeker account with during Step I. More specifically, the remote server begins the selection process for the plurality of arbitrary seeker accounts. As such, the corresponding provider PC device prompts the arbitrary provider account to select the winning seeker account from the plurality of arbitrary seeker accounts. In this case, the selection process allows the arbitrary provider account to reject bids from the plurality of arbitrary seeker accounts before accepting a bid from the winning seeker account. Resultantly, a selection for the winning provider account is relayed from the corresponding provider PC device of the arbitrary provider account to the remote server.

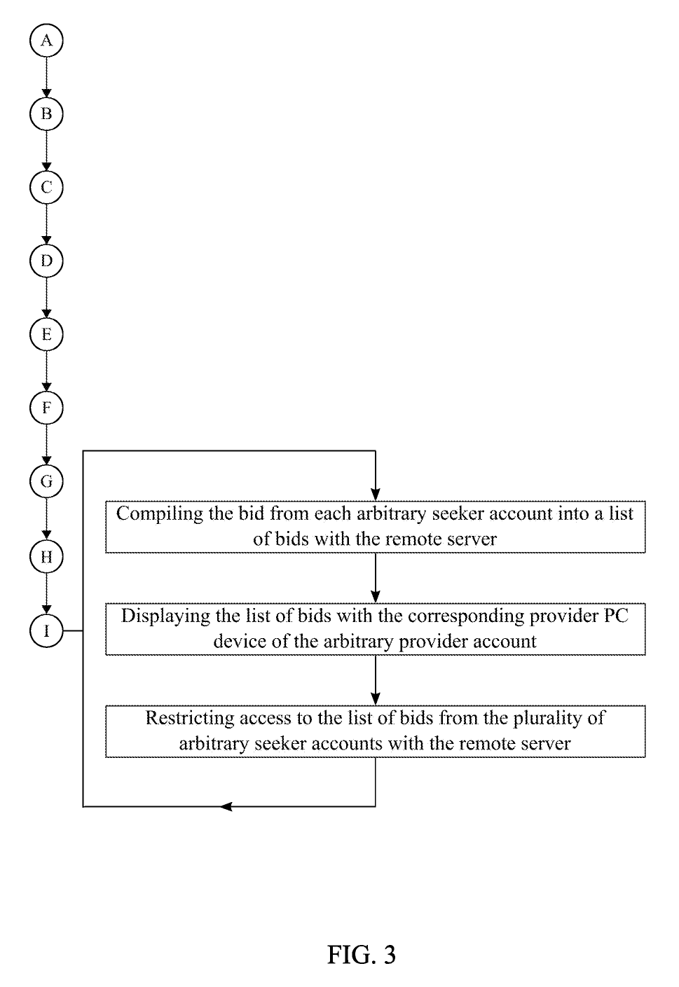

Referring to FIG. 3, in the preceding embodiment, the remote server displays the bid from the plurality of arbitrary provider accounts to the arbitrary provider account. As such, the remote server compiles the bid from each arbitrary seeker account into a list of bids. Further, the list of bids is displayed with the corresponding provider PC device of the arbitrary provider account. Using the list of bids, the arbitrary provider account checks the bid from the plurality of arbitrary seeker accounts. To prevent, the plurality of arbitrary seeker accounts from seeing each other's bid, the list of bids is kept hidden from the plurality of arbitrary seeker accounts. More specifically, the remote server restricts the plurality of arbitrary seeker accounts from accessing the list of bids from the remote server. This prevents the plurality of desired accounts from bidding too low.

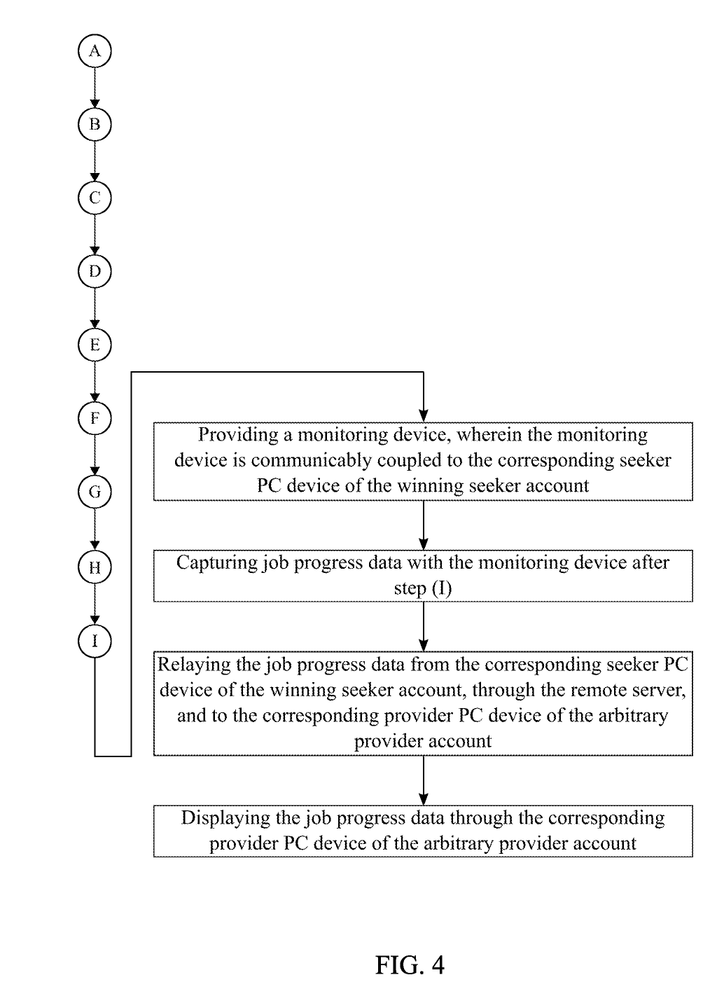

Referring to FIG. 4, in the preferred embodiment, the arbitrary provider account can monitor the user as he or she is performing the job. As such, a monitoring device is provided, wherein the monitoring device is communicably coupled to the corresponding seeker PC device of the winning seeker account. The monitoring device as herein referred to, includes but is not limited to, a webcam, a chest-cam, and/or sensors (e.g. a location sensor, accelerometer, orientation sensor). The monitoring device captures job progress data during Step I. For example, in one possible embodiment, the job progress data may be stored on the internal memory of the corresponding PC device and transmitted periodically to the remote server.

Referring once more to FIG. 4, preferably, the monitoring device is configured to monitor the job site either periodically or continuously. In one possible embodiment, the monitoring device is the chest-cam that may be worn by the user while performing the job. In another possible embedment, the monitoring device is a webcam that may be positioned to capture a wide-angle view of the job site. In yet another embodiment, the monitoring device is a sensor that captures the location, acceleration, heading, elevation of the user/s or equipment at the job site. Preferably, the arbitrary provider account accesses the job progress data from the remote server. As such, the remote server relays the job progress data from the corresponding seeker PC device of the winning seeker account to the corresponding provider PC device of the arbitrary provider account. Preferably, the remote server allows the corresponding provider PC device to stream real-time data from the monitoring device of the corresponding seeker PC device. Further, the remote server may also archive the job progress data captured over several days, weeks, or months. Subsequently, the job progress data is displayed through the corresponding provider PC device of the arbitrary provider account. Depending on the type of monitoring device used, the corresponding provider PC device may output video, audio, graphs, or charts.

In one possible embodiment, the job progress data is continuously captured by the monitoring device. In this case, the job progress data is transmitted directly from the corresponding seeker PC device to the remote server. As such, the corresponding seeker PC device may not store the job progress data locally.

Alternately, the job progress data may be periodically captured by the monitoring device. As such, the corresponding seeker PC device may store the data locally as well as transmitting the job progress data to the remote server.

Referring to FIG. 5, in the preferred embodiment, the contextual data for each seeker account is at least compared to the description of the job request. As such, the corresponding provider PC device prompts each provider account to submit a job description with the job request during Step C. Preferably, the job description includes, but is not limited to, a title, a brief description, a detailed description, a desired work schedule, and the location of the job site. The remote server then compares the job description of the job request to the contextual data for each seeker account to compile the plurality of desired accounts. Alternately, the remote server may compare the contextual data of each seeker account to the contextual data of the arbitrary provider account.

Referring to FIG. 6, further, the remote server provides an accumulative seeker reputation rating for each seeker, wherein the contextual data includes the accumulative seeker reputation rating. The accumulative seeker reputation rating provides a means to assess the capabilities of the seeker account based on the history of performance in prior jobs. For example, the accumulative seeker reputation rating may be derived from the reviews and ratings given by one or more provider accounts on past jobs. Subsequently, the best-match weight is proportionately adjusted for each seeker account based on the accumulative seeker reputation rating during Step E. In one possible embodiment, the accumulative seeker reputation rating may be one or several datapoints used to adjust the best-match weight. Each of the datapoint may have different levels of impact the best-match weight. For example, the accumulative seeker reputation rating may have less of an impact on the best-match weight than the location of the seeker account.

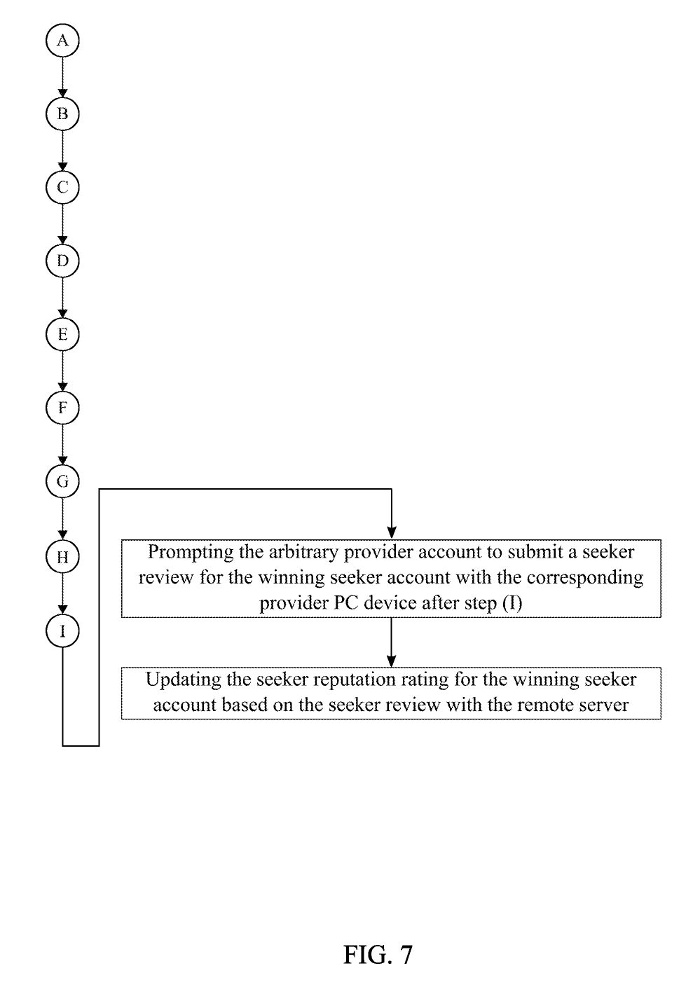

Referring to FIG. 7, preferably, the corresponding provider PC device prompts the arbitrary provider account to submit a seeker review after Step I. The seeker review, as herein referred to, may include both qualitative and quantitative reviews such as written testimonials, numerical ratings, star-based ratings, and the like. In one possible embodiment, the arbitrary provider account gives the seeker review after the winning seeker account is chosen. In another possible embodiment, the arbitrary provider account may give the seeker review if the winning seeker account cancels the job request. In another embodiment, the arbitrary provider account may give the seeker review once the winning seeker account completes the job. Subsequently, the remote server updates the accumulative seeker reputation rating for the winning seeker account based on the seeker review. More specifically, the remote server may simply use the seeker review to calculate the accumulative seeker reputation rating for the winning seeker, or the remote server may filter out outlying seeker reviews.

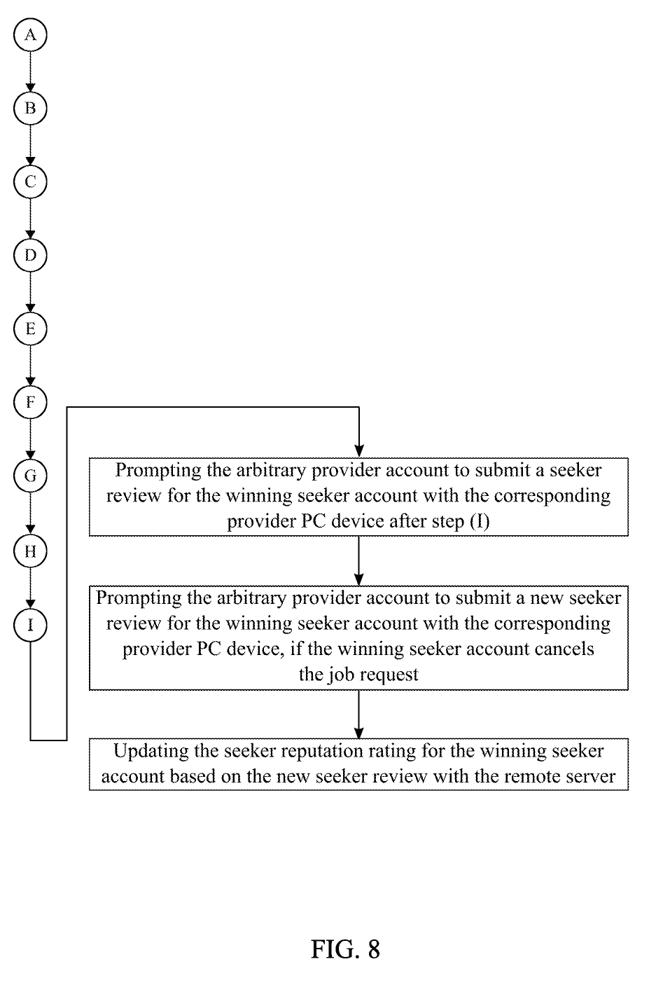

Referring to FIG. 8, in one possible embodiment, the winning seeker account may cancel the job request after the selection process. As such, the corresponding seeker PC device prompts the winning seeker account to cancel the job request after Step I. Preferably, if the winning seeker account cancels the job request after accepting the job request, the arbitrary provider account may change the accumulative seeker reputation rating. Accordingly, the corresponding provider PC device prompts the arbitrary provider account to submit a new seeker review for the winning seeker account, if the winning seeker account cancels the job request. The remote server then updates the accumulative seeker reputation rating for the winning seeker account based on the new seeker review. This function discourages the winning account from suddenly canceling the job request.

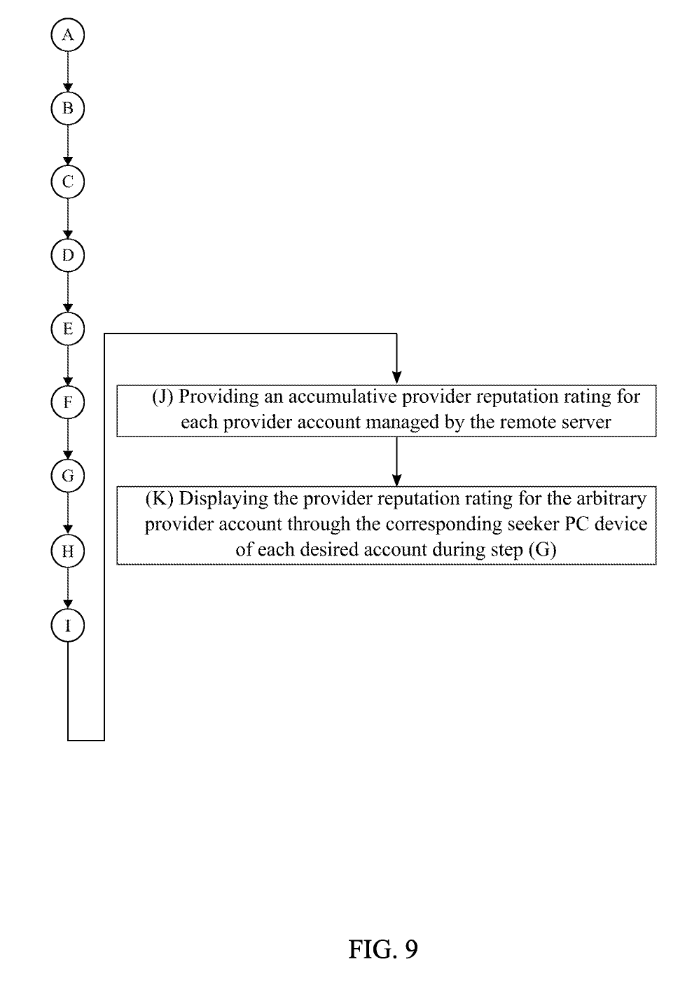

Referring to FIG. 9, likewise, the winning seeker account can also rate and review the arbitrary provider account. As such, the remote server provides an accumulative provider reputation rating for each provider account. The accumulative provider reputation rating provides a means to assess the reputation of the arbitrary provider account based on the interaction with one or more winning seeker accounts. Preferably, the corresponding seeker PC device of each desired account displays the accumulative provider reputation rating for the arbitrary provider account during Step G. More specifically, the accumulative provider reputation rating may be visible to each desired account before, during, or after the selection process.

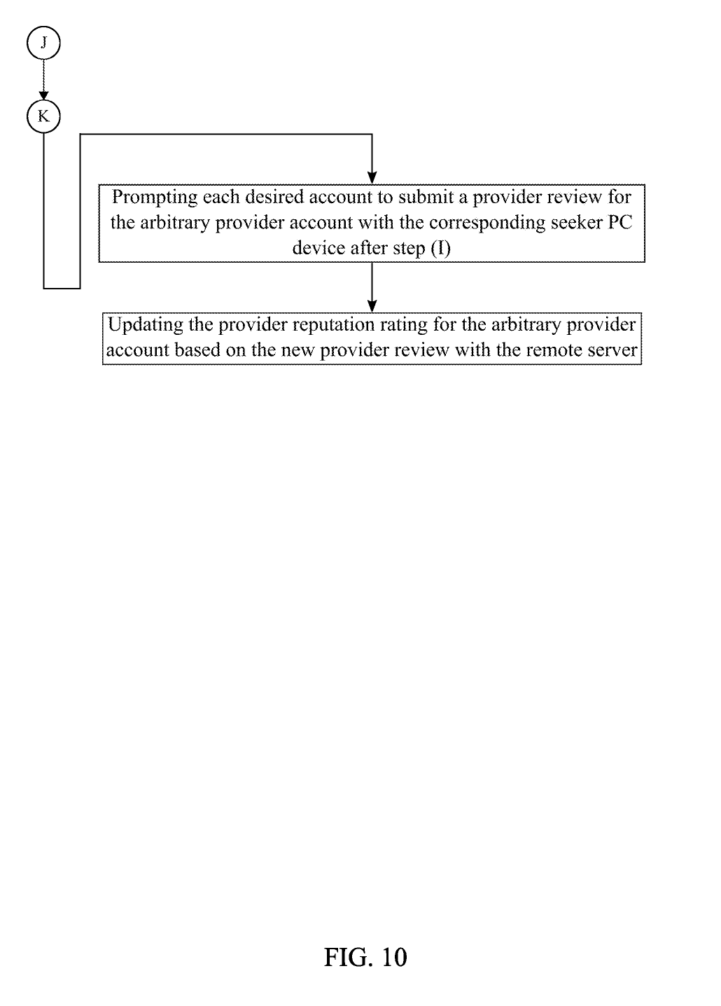

Referring to FIG. 10, in the preferred embodiment, the accumulative provider reputation rating is based on the historical ratings and reviews given to the arbitrary provider account by one or more winning seeker accounts. The corresponding seeker PC device prompts each desired account to submit a provider review for the arbitrary provider account after Step I. Thereafter, the remote server updates the accumulative provider reputation rating for the arbitrary provider account based on the provider review of each desired account. More specifically, the remote server may simply use the provider review to calculate the accumulative provider reputation rating for the arbitrary provider account, or the remote server may filter out outlying provider reviews.

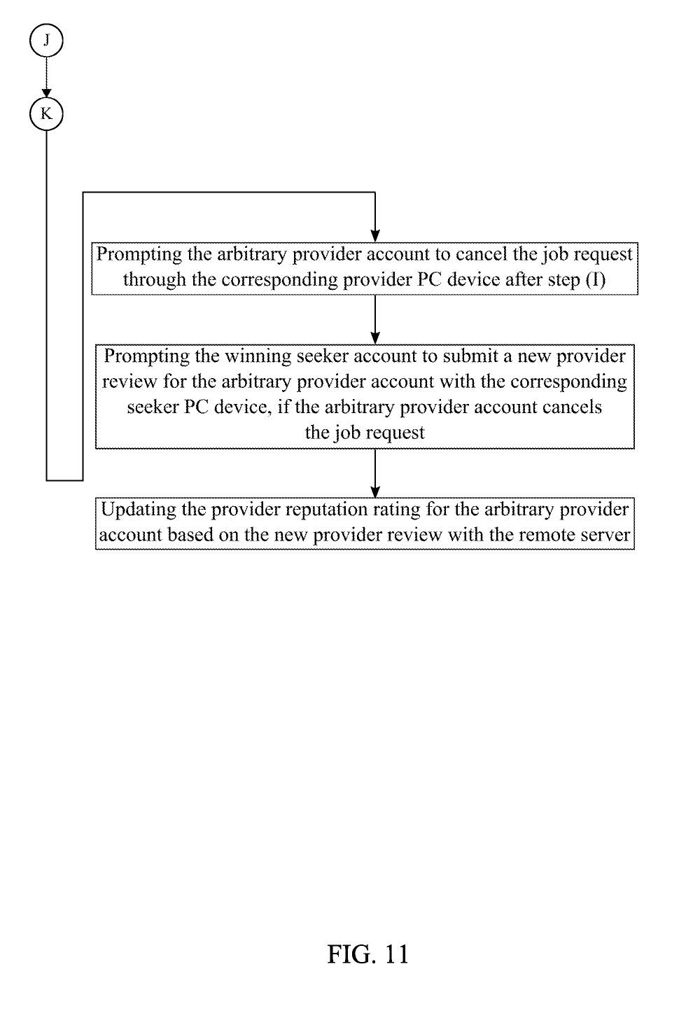

Referring to FIG. 11, in one possible embodiment, the arbitrary provider account may cancel the job request after the selection process. Resultantly, the corresponding PC device prompts the arbitrary provider account to cancel the job request after Step I. This allows the winning seeker account to change the provider review if the arbitrary provider account unfairly cancels the job request. Subsequently, the corresponding seeker PC device prompts the winning seeker account to submit a new provider review for the arbitrary provider account, if the arbitrary provider account cancels the job request. Finally, the remote server updates the accumulative provider reputation rating for the arbitrary provider account based on the new provider review. This function discourages the arbitrary provider account from suddenly canceling the job request.

Referring to FIG. 12, in one possible embodiment, the location of the corresponding seeker PC device is used as the contextual data. A current location is provided within the contextual data for each seeker account. Similarly, a job site for the job request is also provided. Both the current location and the job site is preferably tracked by the corresponding seeker PC device and communicated to the remote server. The current location and the job site may be defined as, but not limited to, an address, landmark, drop-pin, geographical coordinates, network location, preset location stored in memory, or any other means to specify a location. Subsequently, the remote server calculates a travel distance between the current location for each seeker account and the job site. Preferably, the best-match weight for each seeker account is inverse-proportionately adjusted based on the travel distance during Step E. Accordingly, the best-match weight of the seeker account is decreases, as travel distance increases. Alternately, the best-match weight increases and the travel distance decreases. Thus, seeker account closest to the job site is given the highest preference.

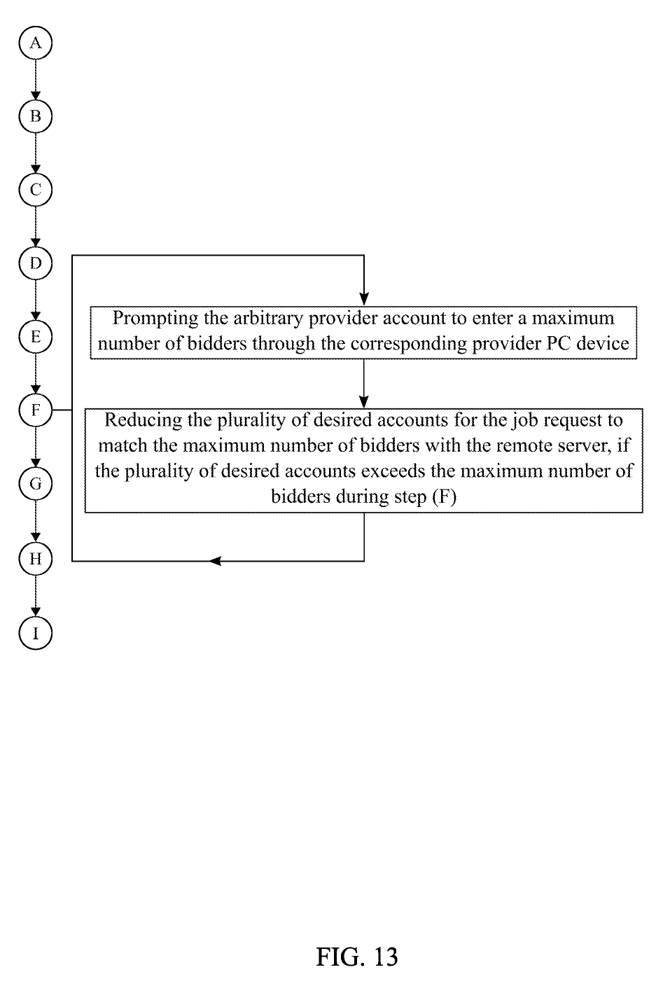

Referring to FIG. 13, in the preferred embodiment, the arbitrary provider account may set a maximum number of bidders to ensure limit the number of bids that can be placed. As such, the corresponding provider PC device prompts the arbitrary provider account to enter a maximum number of bidders. The maximum number of bidders is used by remote server to filter the plurality of desired accounts. As such, the remote server reduces the plurality of desired accounts for the job request to match the maximum number of bidders, if the plurality of desired accounts exceeds the maximum number of bidders during Step F. Since the plurality of desired accounts is ordered according to the best-match weight of each desired account, only the desired accounts with the highest best-match weights remain. Subsequently, each of the remaining plurality of desired accounts is solicited for a bid.

Further, the arbitrary provider account and the winning seeker account may initiate a dispute from the job board. Accordingly, when a dispute occurs, the job board may be locked, but the messages may still be sent on the job board between the winning seeker account and the arbitrary provider account. Furthermore, the winning seeker account and the arbitrary provider account may both choose to resolve a dispute and once the customer and the worker choose to resolve the dispute, the job board may unlock, and the dispute may be terminated. Further, the dispute may automatically be escalated to a dispute resolution process within the system, if a timeframe to allow the customer and the worker to resolve their dispute is expired. Further, if resolution does not occur within the maximum timeframe, the dispute automatically closes and the job board may be closed. Furthermore, the dispute process may change depending on local laws, regulations, and codes. Accordingly, the dispute process information may be specified in the terms of service agreements.

Although the invention has been explained in relation to its preferred embodiment, it is to be understood that many other possible modifications and variations can be made without departing from the spirit and scope of the invention as hereinafter claimed.

What is claimed is:

1. A method of facilitating quality work relationships between job seekers and job providers, the method comprises the steps of:
(A) providing a plurality of seeker accounts managed by at least one remote server, wherein each seeker account includes contextual data and is associated to a corresponding seeker personal computing (PC) device;
(B) providing a plurality of provider accounts managed by the remote server, wherein each provider account is associated to a corresponding provider PC device, and wherein each provider account includes contextual data;
(C) prompting each provider account to post a job request through the corresponding provider PC device;
(D) relaying the job request from at least one arbitrary provider account from the corresponding provider PC device to the remote server, wherein the arbitrary provider account is any one from the plurality of job seeker accounts;
(E) comparing the job request to the contextual data for each seeker account in order to assess a best-match weight for each seeker account;
(F) compiling a plurality of desired accounts for the job request based on the best-match weight of each seeker account with the remote server;
(G) prompting each desired account to enter a bid for the job request through the corresponding seeker PC device;
(H) relaying the bid of at least one arbitrary seeker account from the corresponding seeker PC device, to the remote server, and to the corresponding provider account of the at least one arbitrary provider account, wherein the arbitrary seeker account is any one from the plurality of desired accounts; and
(I) designating a winning seeker account from the at least one arbitrary seeker account with the remote server, if a selection process is executed between the remote server and the corresponding provider PC device of the arbitrary provider account.

2. The method of facilitating quality work relationships between job seekers and job providers, the method as claimed in claim 1 comprises the steps of:
providing the at least one arbitrary seeker account as a plurality of arbitrary seeker accounts;
displaying the bid from each arbitrary seeker account with the corresponding provider PC device of the arbitrary provider account during step (I);
prompting the arbitrary provider account to select the winning seeker account from the plurality of arbitrary seeker accounts through the corresponding provider PC device; and
relaying a selection for the winning provider account from the corresponding provider PC device of the arbitrary provider account to the remote server.

3. The method of facilitating quality work relationships between job seekers and job providers, the method as claimed in claim 2 comprises the steps of:
compiling the bid from each arbitrary seeker account into a list of bids with the remote server;
displaying the list of bids with the corresponding provider PC device of the arbitrary provider account; and
restricting access to the list of bids from the plurality of arbitrary seeker accounts with the remote server.

4. The method of facilitating quality work relationships between job seekers and job providers, the method as claimed in claim 1 comprises the steps of:
providing a monitoring device, wherein the monitoring device is communicably coupled to the corresponding seeker PC device of the winning seeker account;
capturing job progress data with the monitoring device after step (I);
relaying the job progress data from the corresponding seeker PC device of the winning seeker account, through the remote server, and to the corresponding provider PC device of the arbitrary provider account; and
displaying the job progress data through the corresponding provider PC device of the arbitrary provider account.

5. The method of facilitating quality work relationships between job seekers and job providers, the method as claimed in claim 4, wherein the job progress data is continuously captured by the monitoring device.

6. The method of facilitating quality work relationships between job seekers and job providers, the method as claimed in claim 4, wherein the job progress data is periodically captured by the monitoring device.

7. The method of facilitating quality work relationships between job seekers and job providers, the method as claimed in claim 1 comprises the steps of:
prompting each provider account to submit a job description with the job request through the corresponding provider PC device during step (C).

8. The method of facilitating quality work relationships between job seekers and job providers, the method as claimed in claim 1 comprises the steps of:
providing an accumulative seeker reputation rating for each seeker account managed by the remote server, wherein the contextual data includes the accumulative seeker reputation rating; and
proportionately adjusting the best-match weight for each seeker account based on the accumulative seeker reputation rating during step (E).

9. The method of facilitating quality work relationships between job seekers and job providers, the method as claimed in claim 8 comprises the steps of:
prompting the arbitrary provider account to submit a seeker review for the winning seeker account with the corresponding provider PC device after step (I); and
updating the accumulative seeker reputation rating for the winning seeker account based on the seeker review with the remote server.

10. The method of facilitating quality work relationships between job seekers and job providers, the method as claimed in claim 8 comprises the steps of:
prompting the winning seeker account to cancel the job request through the corresponding seeker PC device after step (I);
prompting the arbitrary provider account to submit a new seeker review for the winning seeker account with the corresponding provider PC device, if the winning seeker account cancels the job request; and
updating the accumulative seeker reputation rating for the winning seeker account based on the new seeker review with the remote server.

11. The method of facilitating quality work relationships between job seekers and job providers, the method as claimed in claim 1 comprises the steps of:
providing an accumulative provider reputation rating for each provider account managed by the remote server; and
displaying the accumulative provider reputation rating for the arbitrary provider account through the corresponding seeker PC device of each desired account during step (G).

12. The method of facilitating quality work relationships between job seekers and job providers, the method as claimed in claim 11 comprises the steps of:
prompting each desired account to submit a provider review for the arbitrary provider account with the corresponding seeker PC device after step (I); and
updating the accumulative provider reputation rating for the arbitrary provider account based on the provider review of each desired account with the remote server.

13. The method of facilitating quality work relationships between job seekers and job providers, the method as claimed in claim 11 comprises the steps of:
prompting the arbitrary provider account to cancel the job request through the corresponding provider PC device after step (I);
prompting the winning seeker account to submit a new provider review for the arbitrary provider account with the corresponding seeker PC device, if the arbitrary provider account cancels the job request; and
updating the accumulative provider reputation rating for the arbitrary provider account based on the new provider review with the remote server.

14. The method of facilitating quality work relationships between job seekers and job providers, the method as claimed in claim 1 comprises the steps of:
providing a current location within the contextual data for each seeker account;
providing a job site for the job request;
calculating a travel distance between the current location for each seeker account and the job site with the remote server; and
inverse-proportionately adjusting the best-match weight for each seeker account based on the travel distance during step (E).

15. The method of facilitating quality work relationships between job seekers and job providers, the method as claimed in claim 1 comprises:
prompting the arbitrary provider account to enter a maximum number of bidders through the corresponding provider PC device; and
reducing the plurality of desired accounts for the job request to match the maximum number of bidders with the remote server, if the plurality of desired accounts exceeds the maximum number of bidders during step (F).
